(19) United States
(12) Patent Application Publication
(10) Pub. No.: US 2022/0259489 A1
(43) Pub. Date: Aug. 18, 2022

(54) LIGHT CONVERSION COMPOSITE MATERIAL ASSEMBLY AND METHOD OF MANUFACTURING A LIGHT CONVERSION COMPOSITE MATERIAL ASSEMBLY

(71) Applicant: Skiileux Electricity Inc., Taoyuan City (TW)

(72) Inventor: Jian-Ging Chen, Taoyuan City (TW)

(73) Assignee: Skiileux Electricity Inc., Taoyuan City (TW)

(21) Appl. No.: 17/542,479

(22) Filed: Dec. 5, 2021

(30) Foreign Application Priority Data
Feb. 17, 2021 (TW) 110105208

(51) Int. Cl. C09K 11/02

(52) U.S. Cl. CPC C09K 11/02

(57) ABSTRACT

A light conversion composite material assembly includes at least one light conversion material and a carrier. The at least one light conversion material is distributed inside the carrier. The carrier is formed by a mixture. The mixture includes at least one inorganic material and at least one organic material. The at least one inorganic material includes a mica. A method of manufacturing the light conversion composite material assembly includes placing the light conversion material, the inorganic material including the mica and the organic material into a solvent to form a mixture solution; heating the mixture solution up to a first temperature, so that the organic material is dissolved in the mixture solution and the inorganic material is suspended in the mixture solution; and cooling the mixture solution down to a second temperature, so that the light conversion composite material assembly is separated out from the mixture solution.

### BACKGROUND OF THE INVENTION

### 1. Field of the Invention

The present invention relates to a composite material and related manufacturing method, and more specifically, to a light conversion composite material assembly, which has better reliability, and a method of manufacturing the aforementioned light conversion composite material assembly.

### 2. Description of the Prior Art

A light conversion composite material, such as a quantum dot or a phosphor, can convert blue light emitted from a light emitting component, such as a light emitting diode (LED) chip, to light of another wavelength, such as red light or green light. The red light and the green light converted by the light conversion composite material and the blue light generated by the light emitting component can be combined together in different proportions to form light of various colors. Therefore, a display panel provided with the light conversion material can have a better color purity and a wider display color gamut. However, the light conversion material tends to react with water or oxygen and becomes failed. Therefore, improvement of reliability of the light conversion material has become an important issue.

### SUMMARY OF THE INVENTION

It is an objective of the present invention to provide a light conversion composite material assembly, which has better reliability, and a method of manufacturing the aforementioned light conversion composite material assembly for solving the aforementioned problem.

In order to achieve the aforementioned objective, the present invention discloses a light conversion composite material assembly. The light conversion composite material assembly includes at least one light conversion material and a carrier. The at least one light conversion material is distributed inside the carrier. The carrier is formed by a mixture. The mixture includes at least one inorganic material and at least one organic material, and the at least one inorganic material includes a mica.

According to an embodiment of the present invention, the at least one inorganic material further includes at least one of a silicon oxide and a titanium oxide.

According to an embodiment of the present invention, the at least one organic material includes at least one of a polyethylene and a polycarbonate.

According to an embodiment of the present invention, the at least one organic material includes at least one of a polyethylene and a polycarbonate.

According to an embodiment of the present invention, the at least one light conversion material is a quantum dot or a phosphor.

According to an embodiment of the present invention, the at least one light conversion material is disposed within the mica.

According to an embodiment of the present invention, the light conversion composite material assembly is in a powder form or in a film form.

In order to achieve the aforementioned objective, the present invention discloses a method of manufacturing a light conversion composite material assembly. The method includes placing a light conversion material, an inorganic material including a mica, and an organic material into a solvent to form a mixture solution; heating the mixture solution up to a first temperature, so that the organic material is dissolved in the mixture solution and the inorganic material is suspended in the mixture solution; and cooling the mixture solution down to a second temperature, so that the light conversion composite material assembly is precipitated from the mixture solution.

According to an embodiment of the present invention, the solvent is an aromatic hydrocarbon.

According to an embodiment of the present invention, the first temperature is not less than 80 degrees Celsius and not greater than 150 degrees Celsius.

According to an embodiment of the present invention, the second temperature is not less than 20 degrees Celsius and not greater than 60 degrees Celsius.

According to an embodiment of the present invention, the method further includes removing the solvent by centrifuging, filtrating and drying the cooled mixture solution, so as to obtain the light conversion composite material assembly in a powder form.

According to an embodiment of the present invention, the method further includes coating the cooled mixture solution on a substrate; and removing the solvent by heating, so as to obtain the light conversion composite material assembly in a film form.

In summary, in the present invention, the light conversion materials are distributed inside the carrier, and the carrier is formed by the mixture including the inorganic material including the mica, and the organic material. The light conversion material can be located within the organic material or between the micas, or even between lamellar structure of the mica. Water or oxygen can be blocked by the organic material, the micas and/or the lamellar structure of the mica, so that the light conversion material is prevented from failure due to reaction of the light conversion material with the water or the oxygen. Therefore, the light conversion composite material assembly of the present invention has better reliability, and it is not required to dispose any additional shielding layer or film to block the water and the oxygen as in the prior art. Besides, the aforementioned method has short reaction time, which facilitates rapid mass production.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram of a light conversion composite material assembly according to an embodiment of the present invention.

FIG. 2 is a diagram of the light conversion composite material assembly in a powder form according to the embodiment of the present invention.

FIG. 3 is a diagram of the light conversion composite material assembly in a film form according to the embodiment of the present invention.

FIG. 4 is a flow chart of a method of manufacturing the light conversion composite material assembly according to the embodiment of the present invention.

### DETAILED DESCRIPTION

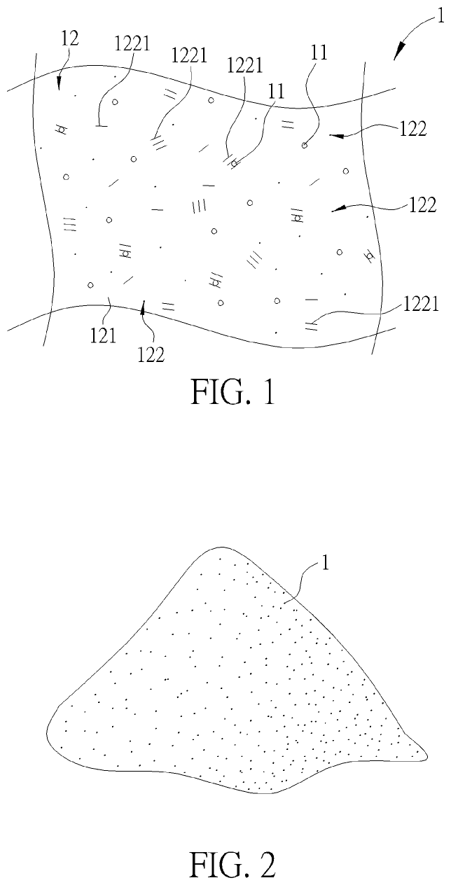

Please refer to FIG. 1 to FIG. 3. FIG. 1 is a structural diagram of a light conversion composite material assembly 1 according to an embodiment of the present invention. FIG. 2 is a diagram of the light conversion composite material assembly 1 in a powder form according to the embodiment of the present invention. FIG. 3 is a diagram of the light conversion composite material assembly 1 in a film form according to the embodiment of the present invention. As shown in FIG. 1 to FIG. 3, the light conversion composite material assembly 1 can be in the powder form or in the film form and includes at least one light conversion material 11 and a carrier 12. In this embodiment, the light conversion composite material assembly 1 includes a plurality of light conversion materials 11 distributed inside the carrier 12. The carrier 12 is formed by a mixture. The mixture includes at least one inorganic material 122 and at least one organic material 121.

Specifically, in this embodiment, the light conversion material 11 can be a quantum dot or a phosphor configured to convert blue light emitted from a light emitting component, such as a light emitting diode (LED) chip, to light of another wavelength, such as red light or green light. However, the present invention is not limited to this embodiment. In another embodiment, the LED chip can emit ultraviolet (UV) light, and the light conversion material can convert the UV light to red light, green light or blue light.

Furthermore, in this embodiment, the inorganic material 122 includes at least one mica 1221, at least one silicon oxide and at least one titanium oxide. The mica 1221 can include lamellar structure which is for blocking water or oxygen and preventing the light conversion material 11 from reacting with the water or the oxygen. The silicon oxide can be silicon dioxide which is for blocking the water or the oxygen and preventing the light conversion material 11 from reacting with the water or the oxygen. The titanium oxide can be titanium dioxide which has properties of high electron conductivity and high refractive index for extending service life and increasing brightness. The organic material 121 can include polyethylene and polycarbonate which are for blocking the water or the oxygen and preventing the light conversion material 11 from reacting with the water or the oxygen. However, the present invention is not limited to this embodiment. For example, in another embodiment, the organic material can include one of the polyethylene and the polycarbonate. Alternatively, in another embodiment, the inorganic material can include only the mica, or include only the mica and one of the silicon oxide and the titanium oxide.

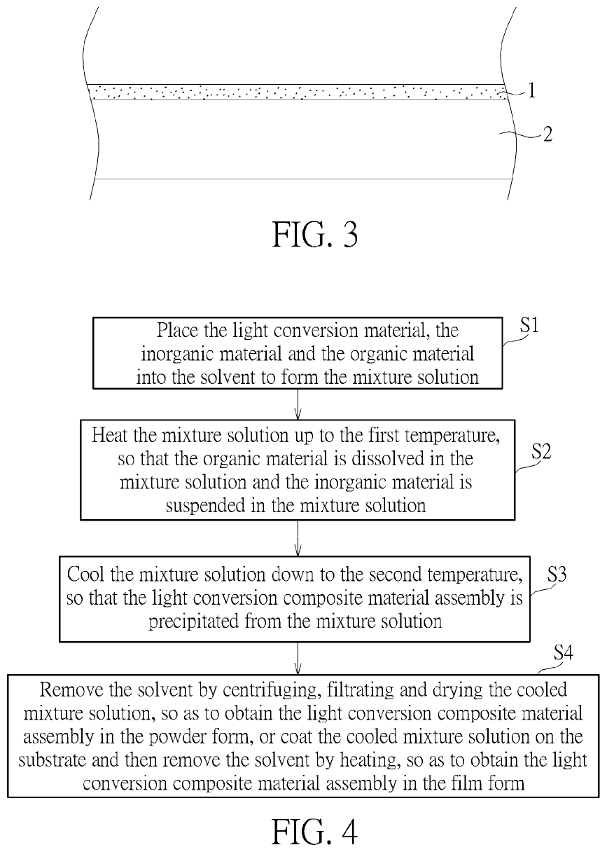

Please refer to FIG. 4. FIG. 4 is a flow chart of a method of manufacturing the light conversion composite material assembly 1 according to the embodiment of the present invention. As shown in FIG. 4, the method includes the following steps:

S1: Place the light conversion material 11, the inorganic material 122 and the organic material 121 into a solvent to form a mixture solution;

S2: Heat the mixture solution up to a first temperature, so that the organic material 121 is dissolved in the mixture solution and the inorganic material 122 is suspended in the mixture solution;

S3: Cool the mixture solution down to a second temperature, so that the light conversion composite material assembly 1 is precipitated from the mixture solution; and

S4: Remove the solvent by centrifuging, filtrating and drying the cooled mixture solution, so as to obtain the light conversion composite material assembly 1 in the powder form, or coat the cooled mixture solution on a substrate 2 and then remove the solvent by heating, so as to obtain the light conversion composite material assembly 1 in the film form.

Detailed description of the above-mentioned steps is provided as follows. When it is desired to manufacture the light conversion composite material assembly 1, the light conversion material 11, the inorganic material 122 and the organic material 121 can be placed into the solvent to form the mixture solution (step S1). Preferably, in one embodiment, the solvent can be aromatic hydrocarbon, such as toluene. However, the present invention is not limited thereto. Afterwards, the mixture solution can be heated up to the first temperature, so that the organic material 121 is dissolved in the mixture solution and the inorganic material 122 is suspended in the mixture solution (step S2). Preferably, in one embodiment, the first temperature can be not less than 80 degrees Celsius and not greater than 150 degrees Celsius. After the mixture solution is heated up to the first temperature, the mixture solution can be stirred at a stirring speed not less than 100 RPM for at least ten minutes, so that the organic material 121 is dissolved in the mixture solution and the inorganic material 122 is suspended in the mixture solution. However, the present invention is not limited thereto.

When the organic material 121 is dissolved in the mixture solution and the inorganic material 122 is suspended in the mixture solution, the mixture solution can be cooled down to the second temperature, so that the light conversion composite material assembly 1 is precipitated from the mixture solution (step S3). Preferably, in an embodiment, the second temperature can be not less than 20 degrees Celsius and not greater than 60 degrees Celsius, and a cooling rate can be not less than 0.1 degrees Celsius per minute and not greater than 20 degrees Celsius per minute. However, the present invention is not limited thereto. The cooling rate can determine a size of the light conversion composite material assembly 1. The higher cooling rate leads to the smaller light conversion composite material assembly 1. Therefore, the cooling rate can depend on practical demands. After the light conversion composite material assembly 1 is precipitated from the mixture solution, the solvent can be removed by centrifuging, filtrating and drying the cooled mixture solution, so as to obtain the light conversion composite material assembly 1 in the powder form, as shown in FIG. 2, or the solvent can be removed by heating after the cooled mixture solution is coated on the substrate 2, so as to obtain the light conversion composite material assembly 1 in the film form as shown in FIG. 3 (step S4). Preferably, in an embodiment, the cooled mixture solution can be coated on a side of the substrate 2 by rollers. However, the present invention is not limited thereto. For example, in another embodiment, the cooled mixture solution can be coated on two sides of the substrate by scrapers.

In this embodiment, the light conversion materials 11 are distributed inside the carrier 12, and the carrier 12 is formed by the mixture including the inorganic material 122 including the mica 1221, and the organic material 121. The light conversion material 11 can be located within the organic material 121 or between the micas 1221, or even between the lamellar structure of the mica 1221. The water or the oxygen can be blocked by the organic material 121, the micas 1221 and/or the lamellar structure of the mica 1221, so that the light conversion material 11 is prevented from failure due to reaction of the light conversion material 11 with the water or the oxygen. Therefore, the light conversion composite material assembly 1 of the present invention has better reliability, and it is not required to dispose any additional shielding layer or film to block the water and the oxygen as in the prior art. Besides, the aforementioned method has short reaction time, which facilitates rapid mass production.

Understandably, in another embodiment, even if composition of the organic material or composition of the inorganic material is different from the one of the aforementioned embodiment, e.g., the organic material includes only one of the polyethylene and the polycarbonate or the inorganic material includes only the mica, or includes only the mica and one of the silicon oxide and the titanium oxide, the light conversion composite material assembly still can be manufactured by the aforementioned method.

Besides, in order to achieve the light conversion composite material assembly with better reliability, in a preferred embodiment, a weight ratio of the light conversion material to the mica to the silicon oxide to the titanium oxide to the polyethylene to the polycarbonate to the toluene in percentage is 15:3:1:1:20:10:50.

Alternatively, in another preferred embodiment, a weight ratio of the light conversion material to the mica to the polyethylene to the polycarbonate to the toluene in percentage is 15:5:20:10:50.

Alternatively, in another preferred embodiment, a weight ratio of the light conversion material to the mica to the polyethylene to the toluene in percentage is 15:5:30:50.

In contrast to the prior art, the light conversion materials are distributed inside the carrier, and the carrier is formed by the mixture including the inorganic material including the mica, and the organic material. The light conversion material can be located within the organic material or between the micas, or even between lamellar structure of the mica. The water or the oxygen can be blocked by the organic material, the micas and/or the lamellar structure of the mica, so that the light conversion material is prevented from failure due to reaction of the light conversion material with the water or the oxygen. Therefore, the light conversion composite material assembly of the present invention has better reliability, and it is not required to dispose any additional shielding layer or film to block the water and the oxygen as in the prior art. Besides, the aforementioned method has short reaction time, which facilitates rapid mass production.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light conversion composite material assembly comprising:
at least one light conversion material; and
a carrier, the at least one light conversion material being distributed inside the carrier, the carrier being formed by a mixture, the mixture comprising at least one inorganic material and at least one organic material, and the at least one inorganic material comprising a mica.

2. The light conversion composite material assembly of claim 1, wherein the at least one inorganic material further comprises at least one of a silicon oxide and a titanium oxide.

3. The light conversion composite material assembly of claim 2, wherein the at least one organic material comprises at least one of a polyethylene and a polycarbonate.

4. The light conversion composite material assembly of claim 1, wherein the at least one organic material comprises at least one of a polyethylene and a polycarbonate.

5. The light conversion composite material assembly of claim 1, wherein the at least one light conversion material is a quantum dot or a phosphor.

6. The light conversion composite material assembly of claim 1, wherein the at least one light conversion material is disposed within the mica.

7. The light conversion composite material assembly of claim 1, wherein the light conversion composite material assembly is in a powder form or in a film form.

8. A method of manufacturing a light conversion composite material assembly, the method comprising:
placing a light conversion material, an inorganic material comprising a mica, and an organic material into a solvent to form a mixture solution;
heating the mixture solution up to a first temperature, so that the organic material is dissolved in the mixture solution and the inorganic material is suspended in the mixture solution; and
cooling the mixture solution down to a second temperature, so that the light conversion composite material assembly is precipitated from the mixture solution.

9. The method of claim 8, wherein the solvent is an aromatic hydrocarbon.

10. The method of claim 8, wherein the first temperature is not less than 80 degrees Celsius and not greater than 150 degrees Celsius.

11. The method of claim 8, wherein the second temperature is not less than 20 degrees Celsius and not greater than 60 degrees Celsius.

12. The method of claim 8, further comprising:
removing the solvent by centrifuging, filtrating and drying the cooled mixture solution, so as to obtain the light conversion composite material assembly in a powder form.

13. The method of claim 8, further comprising:
coating the cooled mixture solution on a substrate; and
removing the solvent by heating, so as to obtain the light conversion composite material assembly in a film form.
